(19) United States
(12) Patent Application Publication
(10) Pub. No.: US 2008/0281632 A1
(43) Pub. Date: Nov. 13, 2008

(54) PREDICTIVE BILLING AND COLLECTION FOR MEDICAL SERVICES

(75) Inventor: Craig Poley, Colorado Springs, CO (US)

Correspondence Address: HOGAN & HARTSON LLP, ONE TABOR CENTER, SUITE 1500, 1200 SEVENTEENTH ST, DENVER, CO, 80202, US

(73) Assignee: Nobelus, Inc., Colorado Springs, CO (US)

(21) Appl. No.: 12/111,098

(22) Filed: Apr. 28, 2008

Related U.S. Application Data
(60) Provisional application No. 60/917,585, filed on May 11, 2007.

(51) Int. Cl. G06Q 30/00

(52) U.S. Cl. 705/2

(57) ABSTRACT

A historical analysis of collections derived from professional services is undertaken to determine an average collected value for each particular type of service. Each type of collection is categorized by a plurality of criteria placed into a separate repository or category. Each repository is identified with a particular service code and further categorized by the provider of the service and the payer of the service. From that repository, an average amount of collected fees is determined. Prior to displaying this average value, the present invention determines whether the data is reliable by comparing non-zero entries in the repository to zero entries in the repository. Once the ratio of zero entries to non-zero entries is below a certain value, the average collection amount is released for viewing.

### RELATED APPLICATION

The present application relates to and claims the benefit of priority to U.S. Provisional Patent Application No. 60/917,585 filed May 11, 2007, which is hereby incorporated by reference in its entirety for all purposes as if fully set forth herein.

### BACKGROUND OF THE INVENTION

1. Field of the Invention

Embodiments of the present invention relate, in general, to medical services billing and particularly to systems and methods for predicting billing and collection for medical services.

2. Relevant Background

Medical billing is one of the most difficult processes in management of healthcare. The level of errors in billing has been estimated as high as 40% of all invoices issued by physicians, hospitals, insurance companies and others. Billing errors are such an extensive problem that an entire industry has developed around auditing and readjusting medical bills. As a result, the healthcare industry incurs billions of dollars in additional expense each year. These errors are compounded by the lack of any reliable indicator that a physician or medical group can use to set fees for services based on the likelihood of reimbursement for those services.

Many factors contribute to complicating the medical services billing process. Seemingly, one would think that a given procedure performed by a doctor or a hospital could be billed at an agreed upon price and that a total bill would simply be the sum of those individual procedure costs. However, this is not the case. Complicated combinations of procedures often result in different billing amounts. For example, if a doctor performs procedure A and then, as a result of procedure A, was medically required to perform procedure B, then combination of procedures A and B would be billed, for example, as rate code X. Given the same patient and condition, if the doctor performed procedure A and then, as a precaution, performed procedure B, the precautionary performance of procedure B would be billed, for example, as rate code Y. In this example, an insurance company might not pay the complete amount for a precautionary performance of procedure B (rate code Y), but the insurance company might pay the complete amount for a medically necessary performance of procedure B (rate code X).

Regardless of which of the rate codes X and Y is used, the bill is then submitted to the financially responsible party, often an insurance company. The insurance company now faces a dilemma. If the doctor submitted a bill under rate code X, then the insurance company may question whether the second procedure B was in fact a medical necessity after procedure A or merely a precaution. In order to determine whether procedure B was a medical necessity, the insurance company will typically review doctors's notes on the encounter with the patient and then have their own medical expert decide whether procedure B was in fact medically necessary. The process described above is both costly and time consuming.

The insurance company is not the only one who can suffer in the example provided above. Physicians are often under-compensating themselves because they bill improperly or are completely unaware of a particular billing combination. The under-compensation is compounded in most medical practices as the doctor is rarely involved in the billing. Billing is left to the office staff who are not necessarily sufficiently trained and educated and may not have the expertise to know if a given set of procedures is in the correct sequence for a given code.

Across the various medical specialties, there are thousands of individual procedure codes, and the combinations of codes make the billing process difficult. Since the list of codes and combinations is not static, the problem is compounded. Recently, because of medical advances, some medical specialties are performing procedures not normally in their specialty. Interventional radiology is a prime example. In the past, cardiac procedures that involved imaging were performed by cardiologists. Radiologists, in an effort to increase revenue, have modified cardiac procedures that involve imaging so that they can be performed by radiologists. This change created huge billing confusion and has resulted in companies being formed that do nothing but create bills for interventional radiology practices. With the kinds of billing processes described above, it is estimated that typically only 1 in 6 bills are correctly coded.

Post billing audit companies usually work for either insurance companies or hospitals. They often examine a large block of billing data using typical data mining tools to find bills that fit a certain profile. Once these bills are identified, they are then manually examined by trained personnel in order to discover whether they have been coded properly. If not, the audit company then issues a corrected bill in an attempt to recover the errant dollars. The post billing audit company usually keeps between 30-50% of the recovered funds for performing these services. Of course, these companies only re-bill in a way that favors their client. For example, if an insurance company overpaid a hospital, the audit company would issue a demand for repayment to the hospital. If, however, the same insurance company underpaid the hospital, no correction would be pursued. Some companies have subsidiaries working on the opposite side so that they are collecting money from both parties's mistakes. The post audit industry represents billions of dollars each year using the process described above; these resources are extracted from healthcare and return no benefit to doctors or patients.

As if these challenges in the medical billing process where not enough, they are further complicated in that there has been no attention given to a process for providing physicians or other medical entities a prediction of when revenue from a particular service may actually be received or what portion of the billed amount can be realistically collected. As with most accounting systems, accounts receivable measures the amount that is still left to be collected. Generally such accounts are broken into ages (0-30 days, 31-60, 61-90, 91+). Lacking from this account information is any data conveying what services are likely to produce quick collections and/or to what extent any services will achieve a high percentage of an issued bill.

Most physicians do not have a reproducible or meaningful way to set their charges. They arbitrarily set a charge and update these charges sporadically normally based on the competitive market, but the charges for any given procedure are not correlated with the expected reimbursement (fee) that will be paid. When physicians sign contracts with private insurers to provide care to the insured patients, they agree to accept the reimbursement amount set by the insurer. Similarly, when physicians agree to see patients for government-based plans (Medicare, Medicaid, etc.), the physician agrees to accept the amount set by the government payer.

Medicare publishes its fee schedule annually, and usually private payers (insurance companies) base their reimbursement loosely on Medicare's schedule.

While physicians and other medical service providers may strive to obtain consistent rates across all private insurance contracts, the reality is that most of these contracts have different rates based on different criteria. Thus the same code for service rendered might be worth A to one payer and B to another. And, as explained above, the likelihood of collecting either A or B may vary from one payer to the next. This means the accounts receivable for that single charge could be off by as much as 50-75% for the same service.

An unfortunate reality of the medical profession is that the billing cycle between services rendered and payments received is so great that physicians and other medical professionals lose perspective on the value of their services and any ability to measure their productivity. Making the collection puzzle more ambiguous is the fact that collections that are being received presently can represent services provided an extremely long time ago. In many circumstances, insurance companies stall payments for a myriad of reasons. The most common reason to delay payment is also the most simple: when the insurer delays a payment after the initial contact from the physician or billing office, there is an almost 30% chance that the insurer will not have to make that payment due to a lack of follow-up by the physician or billing office.

Thus there remains a need to enable physicians and other medical professionals to understand what delayed and incorrect payments of services are reasonable to pursue. Physicians desire the ability to know what collections can be reasonably expected for a given service (code) regardless of the amount of charge, the contract rate, the contract year, the payer or the provider. These and other needs are addressed by the present invention.

### SUMMARY OF THE INVENTION

A system and method for predicting collections of services billed is disclosed. According to one embodiment of the present invention, a historical analysis of collections derived from professional services is undertaken to determine an average collected value for each particular type of service. Each type of service is categorized by a plurality of criteria including, in one embodiment of the present invention, the type or identification of the provider of that service as well as identification of the payer of the service.

One aspect of the present invention is to identify when a repository of data is sufficient to reliably provide projected payments of billed services. According to the present invention, a plurality of repositories is created from received collection data. Each repository is identified with a particular service code and further categorized by the provider of the service and the payer of the service. From each repository, an average amount of collected fees is determined. Prior to displaying this average or projected value, the present invention further determines whether the data is sufficient to form a reliable prediction. According to one embodiment of the present invention, a ratio is formed by comparing non-zero entries in the repository to zero entries in the repository. Zero entries are representative of denials of payment rather than pending payments that have not yet been received. Once the ratio of zero entries to non-zero entries is below a certain predetermined value, the average collection amount is released for viewing and is used as a projected payment value.

According to another embodiment of the present invention, each repository of collection data is continually updated and the ratio for determining the projection's sufficiency is periodically evaluated. In this manner, the predicted collection value for a particular code of service becomes more accurate over the passing of time.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of a preferred embodiment taken in conjunction with the accompanying drawings, wherein:

FIG. 1 shows a high level block diagram of a system for predicting billing collections according to one embodiment of the present invention;

FIG. 2 is a flowchart of one method embodiment for predicting billing collections from services rendered according to the present invention;

FIG. 3 is a flowchart of one method embodiment for determining whether enough data has been collected and analyzed with respect to an average payment associated with a particular service provider, a particular service payer and for a particular type of service for display to a user; and

FIG. 4 shows a high level block diagram of a general computer system, as is known in the art, capable of implementing the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

A system and method for dynamically and accurately predicting collections from billed services is herein disclosed by way of example. The time from when a professional service is rendered and billed to when the payment for that service is realized can often be extensive. Furthermore, providers of such service are plagued with an often inconsistent and unpredictable flow of revenue for their services. According to one embodiment of the present invention, a system is disclosed for dynamically predicting an average payment for a particular type of rendered service. Rather than focusing on contract and theoretical returns, the present invention gathers data regarding actual payments and determines a predicted payment for a particular type of service rendered by a particular provider and charged to a particular payer.

Using this information, a service provider can accurately predict the time from when a service is rendered to the time payment will likely be received as well as the amount of payment. This amount is an accurate indication of what can be expected from a particular type of rendered service rather than what is actually billed to the payer or what is actually due. In this manner, the service provider can be proactive in budget planning as well as identifying services that efficiently and timely result in compensation.

Specific embodiments of the present invention are hereafter described in detail with reference to the accompanying Figures. Like elements in the various Figures are identified by like reference numerals for consistency. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The present invention is described hereafter by way of example, and more particularly, by way of example of collecting fees from the rendering of medical services. While the rendering of medical service is a particularly applicable field for the use of the present invention, one skilled in the relevant art will recognize that the concepts presented herein are applicable to a wide variety of applications involving the collection of fees from rendered services.

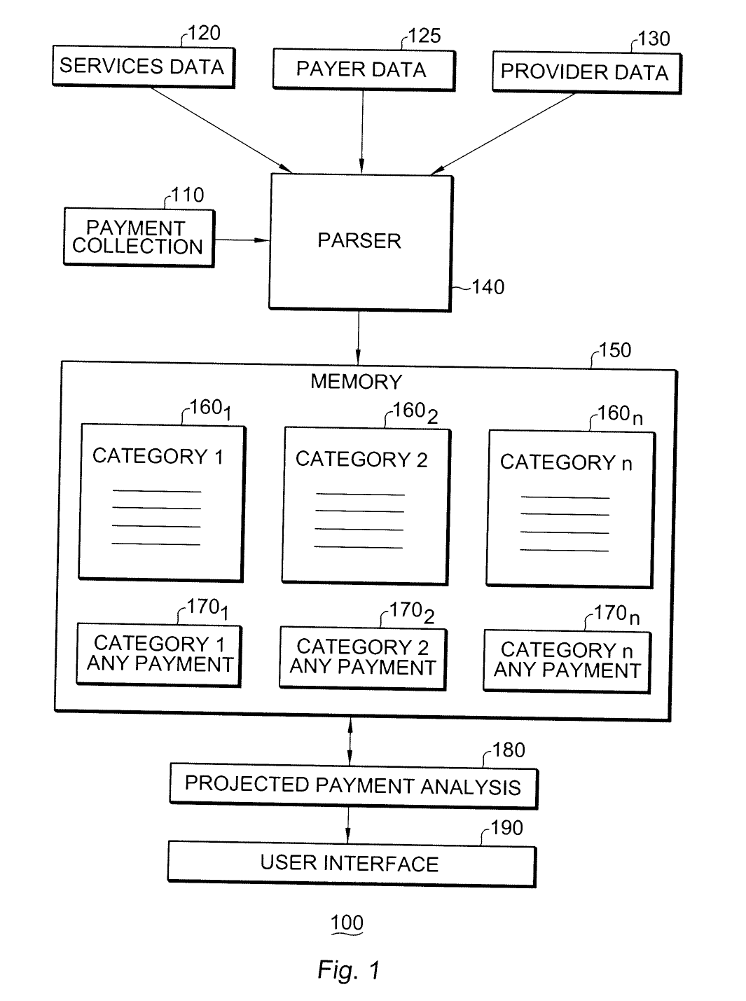

FIG. 1 is a high level block diagram of a system for predicting an average payment of a bill for rendered services according to one embodiment of the present invention. The system 100 shown in FIG. 1 includes a payment collection module 110, a parser module 140 and a projected payment analyzer module 180. According to one embodiment of the present invention, the payment collection module 110 receives a plurality of payments associated with bills (invoices) issued for rendered services.

In the medical profession for example, each rendered medical service is generally categorized into one or more codes. These codes assist providers and payers alike by identifying what type of service has been provided. Normally a physician or other medical professional contracts with payers regarding appropriate fees for particular types of services. Payers can be the Federal Government with respect to Medicare patients, or private insurance companies such as Blue Cross or Aetna. As previously discussed, each payer may allot different disbursements for similar service and the definitions for the services rendered may be slightly different for each payer.

Once the service rendered by the medical professional has been coded, a claim is prepared and compensation requested. The present invention addresses the challenge presented in determining what portion of fees requested (billed) will actually return to the provider of service by way of compensation and, additionally, what time period can be expected before that payment is received.

Embodiments of the present invention determine a projected collection amount. This projected amount reflects the amount reasonably expected for any given code regardless of the charge, contract rate, contract year, payer, or provider (physician) who performed the service. According to one embodiment of the present invention, projected payments are based on past payment history rather than based on charges or based on a theoretical contract rate.

The projected amount looks at the average payment received for each type of service rendered (code) and takes into consideration the physician or service provider who performed the service (code). Furthermore, the payer for that code is also considered when determining the projected amount. From that information, and according to one embodiment of the present invention, a determination is made whether the determined projected amount is reliable and worthy of display to a user.

Turning again to FIG. 1, it can be observed that interposed between a memory 150 and the payment collection module 110 is a parser module 140. The parser module 140 receives data regarding rendered services 120 such as codes for the type of services rendered, payer data 125, and provider data 130 so as to categorize each payment received. Using the data regarding the services rendered, the variety of payers of services and providers of services, the parser categorizes each payment into specific categories. Each payment is categorized based on the type of service, the provider of the service and from whom payment (or denial of payment) was received.

Based on this categorization by the parser 140, a plurality of storage categories 1601, 160₂ . . . 160ₙ are established in a memory 150. In addition, for each payment category 1601, 160₂ . . . 160ₙ established in memory 150, an average payment amount register 170₁, 170₂, 170ₘ is established. Coupled to the memory 150 is a projected payment analysis module 180. The analysis module 180 determines whether sufficient data has been collected and categorized so as to make the average payment amount indicative of what payment for that particular category is likely to be received. Said a different way, the analysis module 180 determines when the average payment amount can be viewed as a projected payment.

According to one embodiment of the present invention, the analysis module 180 determines the number of non-zero entries in each category as well as zero entries. A zero entry, according to one embodiment of the present invention, represents a denial of payment from the provider. To ensure the results are not skewed, services that have been provided but for which payments are pending are not represented by zero entries. In this manner, only payments or denials are recorded for analysis.

Once the number of zero and non-zero entries has been determined, a ratio is calculated. This ratio is thereafter compared to a set of values to determine whether the data present in a particular category is sufficient to support the publication of the average payment amount as a projected payment amount. As will be appreciated by one skilled in the art, a ratio that may qualify one category for display can be different than a ratio of another category.

To better understand the utility of the present invention, consider the following example. Procedures provided by a physician are generally associated with a five digit procedure code. For example, an office visit at a family practice physician would be coded as a 99213 (OFFICE/OUTPATIENT VISIT E&M EST LOW-MOD SEVERITY).

In one state, in 2007, Medicare reimburses $59.57 for code 99213. Most private insurers (payers) will base their reimbursement on Medicare's allowed amount. A physician might have a contract that states 120% of current year Medicare, for example. In this case the contract amount for a 99213 would be $71.96.

If a provider in that state submitted a 99213 to the above payer with a charge of $85, that provider would receive an Explanation of Benefit (“EOB”) with an adjustment (write-off) of $13.04. This would make the allowed amount equal to charge ($85) minus adjustment ($13.04)=$71.96. At this point, this stated amount $71.96 might be paid by the payer, left as patient responsibility, or any combination thereof. In any case, the physician is likely not permitted to bill the patient the difference to the full charge. The physician is generally permitted to bill the patient any balance left unpaid by the payer up to $71.96. Thus, $71.96 is the maximum amount allowed by the payer in this example.

In the industry vernacular, the $71.96 would be the ‘expected’ amount and correlates to the contracted rate between the service provider and the payer. Also, each private payer institutes their own customizations of the contract rate (these are not generally disclosed). So in this example, if code 99213 was billed with an annual physical 99396 (PRD PREVENTATIVE MED E&M ESTAB PT) then the 99213 might not be reimbursable at all. In that case, the physician could not accurately predict what compensation he or she might expect from the services provided.

Turning back to the example, assume the provider expects to receive a total payment of $71.96. Thus, from an accounting perspective, there would be an accounts receivable entry of $71.96.

Over some period of time, assume a payment is received with respect to this outstanding invoice. The time from when the services are rendered to the time the payment is received is also tracked and is referred to herein as time to collection. The payment would be associated with a particular provider, in this case the physician, a service code of 99213, and the payer of the service. Over time, the physician will likely submit a number of services coded 99213. Some of these will be associated with the same payer. One would expect each to have the same value of $71.96, however that is not historically accurate.

In this example, over a period of 4 months, 6 additional payments are received that have similar circumstances. All are based on services from the same provider, paid by the same payer and under the same code. These payments include $71.96, $66.50, $0, $0, $65.96 and $50.00. As shown, each is for a different amount and each is typically associated with a different time to collection. Two denials of fees are recorded. According to one embodiment of the present invention, an average of the 6 payment amounts is calculated as is an average of the time to collection for the payments. These averages are stored in memory and updated dynamically as new payments under that particular category arrive. In this case an average amount collected is $46.63.

Before data with respect to this particular category of payment is displayed, the present invention determines whether the average payment amount and the average time to collection are representative. In this case, seven payments have been received and two of the seven have been zero indicating a denial of payment by the payer. According to one embodiment of the present invention, a ratio of the number of zero entries with respect to the number of non-zero entries is determined. Here that ratio is 2:5 or 0.4.

Ratio (“Pr”) breakpoints, according to one embodiment of the present invention, are as follows: When the Pr<0.150, the projected amounts are displayed with disclaimers indicating the number is accurate to +/−2.5%. When Pr is between 0.150 and 0.235, the projected amounts are displayed with disclaimers indicating the number is accurate to +/−5.0%. When Pr>0.235, the projected amounts are not displayed. Thus in the present example, the data collected does not yet support the display of the average collected amount as a projected payment. One skilled in the art will recognize that these boundary values can change based on various accuracy criteria.

Once the Pr is sufficiently low enough to accurately predict an amount for a type of service rendered by a certain provider and paid by a particular payer, that information can be used to determine a likely collection for a particular time period. For example, assume that a projected payment for the code that is reliable and accurate is $69.00. And assume that the average time to collection is 62 days. By knowing that a certain provider has 6 outstanding invoices for this type of service with the same characteristics, the provider can reasonably assume that within the next 62 days compensation of $414 will be received.

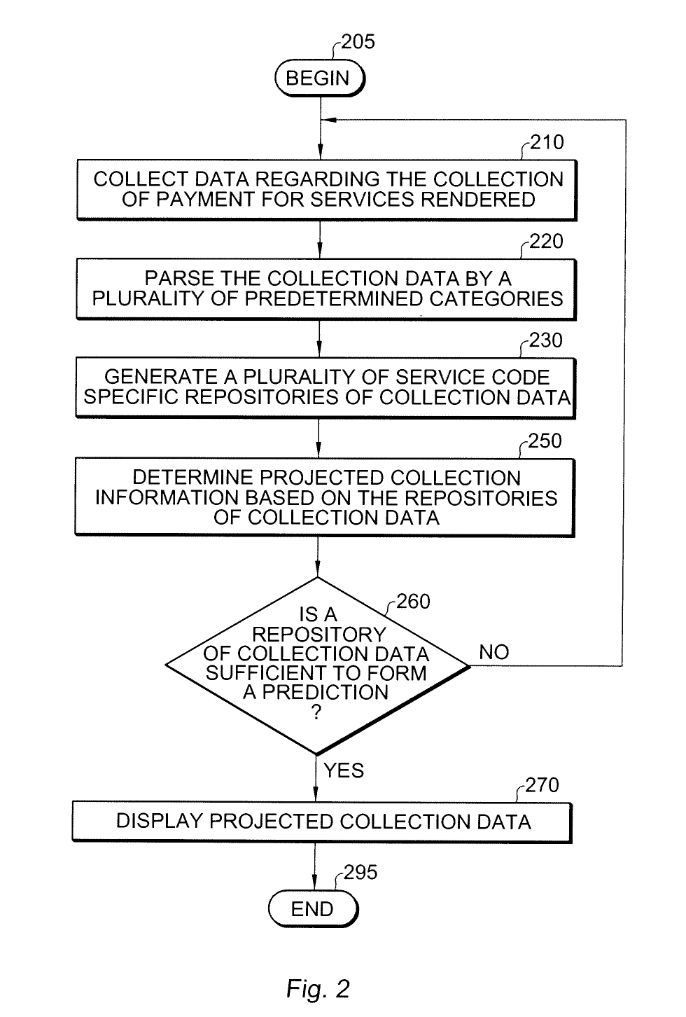

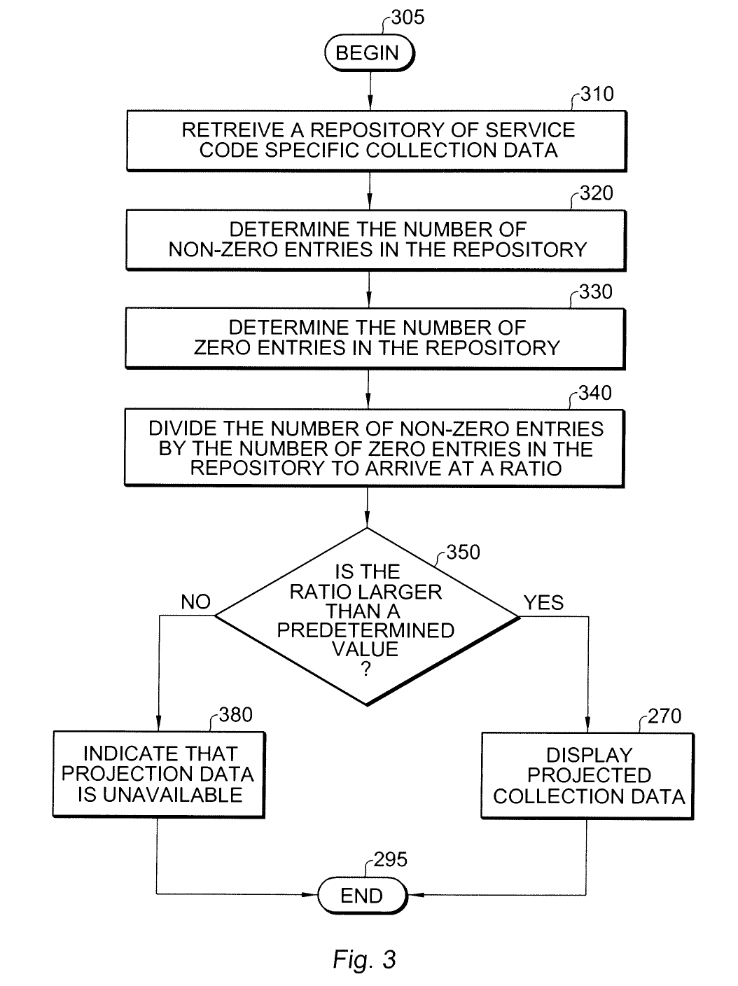

FIGS. 2 and 3 are flowcharts illustrating methods of implementing an exemplary process for predictive billing collections. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

FIG. 2 is a high level flowchart for determining projected collected information. The process begins 205 with the collection 210 of data regarding payment for services rendered. Beyond recording the receipt of each payment, the present invention identifies and associates with each payment the type of service provided, the payer of the service and the provider of the service. The aggregation of received payments is then parsed 220 based on these associations. A plurality of service code specific repositories or categories are created 230 based on the type of service, provider and payer. Data with respect to each payment is stored in a memory based on these criteria. From this data, a projected payment amount is determined 250.

According to one embodiment of the present invention, an average of the payments for each category is determined and thereafter stored in memory. Furthermore, that number is dynamically updated upon the receipt of new data. According to another embodiment of the present invention, different weights are placed on different payments within each category so as to determine the projected amount. For example, a 100% reimbursement by a payer may be given more weight than one that is only a partial reimbursement. These and other implementation methodologies for determining the projected amount are within the scope of the present invention. These implementation methodologies are known within the art and the specifics of their application within the context of the present invention will be readily apparent to one of ordinary skill in the relevant art in light of this specification.

Thereafter, a query 260 is made with respect to whether a repository of data is sufficiently populated to form a payment prediction. Upon a finding that sufficient data is not present, no information is presented to the user and the method continues to collect data and revise the projected payment amount. Responsive to a determination that sufficient data is present in a particular category, the system displays 270 the projected amount via a user interface ending the process 295. The data is also released to other modules for the calculation of projected total collections and other financial values.

FIG. 3 is a flowchart expanding the determination of when a particular category is sufficiently populated to form a reliable projected payment according to one embodiment of the present invention. The determination process begins 305 with the retrieval 310 of data regarding a category of collection data. As previously discussed, each category is a collection of payments having a common payer, provider and service code.

Upon retrieving such data, a determination is made 320 of the number of non-zero payment entries within a particular category. Thereafter a similar determination is made 330 of the number of zero or denial of payment entries within the same particular category. The number of zero entries is then divided 340 by the number of non-zero entries to arrive at a figure representing the ratio of zero to non-zero entries.

A query is then made 350 with respect to the ratio as compared to one or more predetermined values. If the ratio is sufficiently low, the projected payment value is released for display 270. In addition, the projected payment value can be used for other financial calculations. However, when the ratio is above a preset threshold, the data regarding a particular category is deemed insufficient to produce a reliable projected payment. In such instances, a report is issued 380 indicating that data is unavailable. The determination process thereafter ends 395.

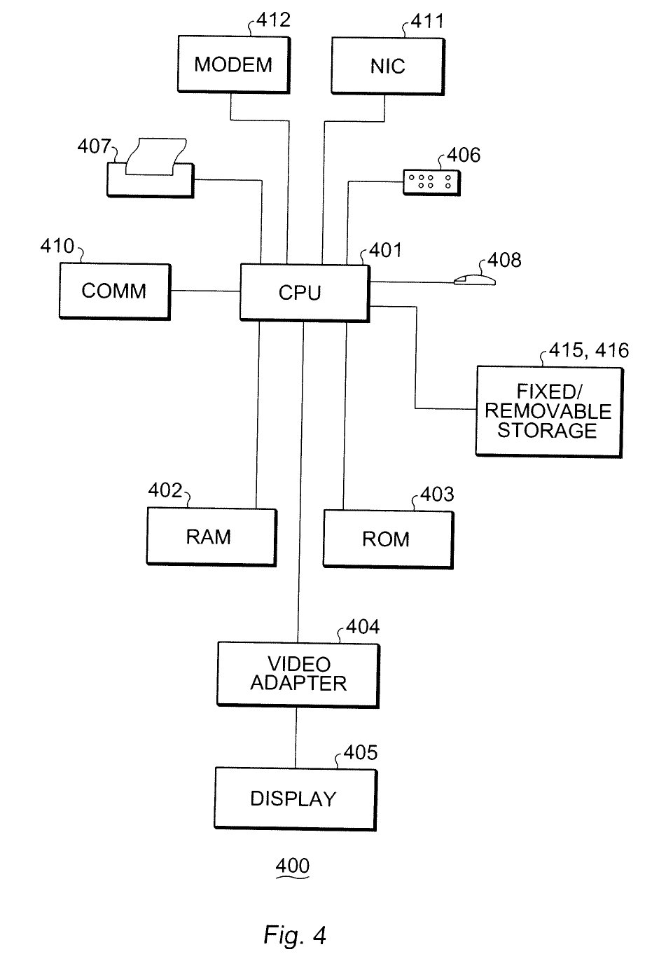

As will be appreciated by one skilled in the relevant art, the present invention may be implemented on a conventional or general-purpose computer system, such as a personal computer (PC), a laptop computer, a notebook computer, a handheld or pocket computer, and/or a server computer. FIG. 4 is a very general block diagram of a computer system in which software-implemented processes of the present invention may be embodied. As shown, system 400 comprises a central processing unit(s) (CPU) or processor(s) 401 coupled to a random-access memory (RAM) 402, a read-only memory (ROM) 403, a keyboard 406, a printer 407, a pointing device 408, a display or video adapter 404 connected to a display device 405, a removable (mass) storage device 415 (e.g., floppy disk, CD-ROM, CD-R, CD-RW, DVD, or the like), a fixed (mass) storage device 416 (e.g., hard disk), a communication (COMM) port(s) or interface(s) 410, a modem 412, and a network interface card (NIC) or controller 411 (e.g., Ethernet). Although not shown separately, a real time system clock is included with the system 400, in a conventional manner.

CPU 401 comprises a suitable processor for implementing the present invention. The CPU 401 communicates with other components of the system via a bi-directional system bus (including any necessary input/output (I/O) controller circuitry and other “glue” logic). The bus, which includes address lines for addressing system memory, provides data transfer between and among the various components. RAM 402 serves as the working memory for the CPU 401. The ROM 403 contains the basic input/output system code (BIOS)—a set of low-level routines in the ROM that application programs and the operating systems can use to interact with the hardware, including reading characters from the keyboard, outputting characters to printers, and so forth.

Mass storage devices 415, 416 provide persistent storage on fixed and removable media, such as magnetic, optical, or magnetic-optical storage systems, flash memory, or any other available mass storage technology. The mass storage may be shared on a network, or it may be a dedicated mass storage. As shown in FIG. 4, fixed storage 416 stores a body of program and data for directing operation of the computer system, including an operating system, user application programs, driver and other support files, as well as other data files of all sorts. Typically, the fixed storage 416 serves as the main hard disk for the system.

In basic operation, program logic (including that which implements methodology of the present invention described below) is loaded from the removable storage 415 or fixed storage 416 into the main (RAM) memory 402, for execution by the CPU 401. During operation of the program logic, the system 400 accepts user input from a keyboard 406 and pointing device 408, as well as speech-based input from a voice recognition system (not shown). The keyboard 406 permits selection of application programs, entry of keyboard-based input or data, and selection and manipulation of individual data objects displayed on the screen or display device 405. Likewise, the pointing device 408, such as a mouse, track ball, pen device, or the like, permits selection and manipulation of objects on the display device. In this manner, these input devices support manual user input for any process running on the system.

The computer system 400 displays text and/or graphic images and other data on the display device 405. The video adapter 404, which is interposed between the display 405 and the system's bus, drives the display device 405. The video adapter 404, which includes video memory accessible to the CPU 401, provides circuitry that converts pixel data stored in the video memory to a raster signal suitable for use by a cathode ray tube (CRT) raster or liquid crystal display (LCD) monitor. A hard copy of the displayed information, or other information within the system 400, may be obtained from the printer 407, or other output device.

The system itself communicates with other devices (e.g., other computers) via the NIC 411 connected to a network (e.g., Ethernet network, Bluetooth wireless network, or the like), and/or modem 412 (e.g., 56K baud, ISDN, DSL, or cable modem), examples of which are available from 3Com of Santa Clara, Calif. The system 400 may also communicate with local occasionally-connected devices (e.g., serial cable-linked devices) via the COMM interface 410, which may include a RS-232 serial port, a Universal Serial Bus (USB) interface, or the like. Devices that will be commonly connected locally to the interface 410 include laptop computers, handheld organizers, digital cameras, and the like.

Personal computers, laptop computers, notebook computers, handheld computers, and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

The computer system of FIG. 4 can also be employed in a network setting such as a local area network or a wide area network and the like. Such networks may also include mainframe computers or servers, such as a gateway computer or application server (which may access a data repository or other memory source). A gateway computer serves as a point of entry into each network. The gateway may be coupled to another network by means of a communications link; it may also be directly coupled to one or more devices using a communications link. Further, the gateway may be indirectly coupled to one or more devices. The gateway computer may also be coupled to a storage device (such as data repository). The gateway computer may be implemented utilizing a variety of architectures.

Those skilled in the art will appreciate that the gateway computer may be located a great geographic distance from the network, and similarly, the devices may be located a substantial distance from the networks as well. For example, the network may be located in California, while the gateway may be located in Texas, and one or more of the devices may be located in New York. The devices may connect to the wireless network using a networking protocol such as the Transmission Control Protocol/Internet Protocol (“TCP/IP”) over a number of alternative connection media, such as cellular phone, radio frequency networks, satellite networks, etc. The wireless network preferably connects to the gateway using a network connection such as TCP or UDP (User Datagram Protocol) over LP, X.25, Frame Relay, ISDN (Integrated Services Digital Network), PSTN (Public Switched Telephone Network), etc. The devices may alternatively connect directly to the gateway using dial connections. Further, the wireless network may connect to one or more other networks (not shown), in an analogous manner.

In preferred embodiments, the present invention is implemented in software. Software programming code that embodies the present invention is typically accessed by the microprocessor from long-term storage media of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory and accessed by the microprocessor using the bus. The techniques and methods for embodying software programming code in memory, on physical media, and/or distributing software code via networks are well known and will not be further discussed herein. An implementation of the present invention may be executing in a Web environment, where software installation packages are downloaded using a protocol such as the HyperText Transfer Protocol (HTTP) from a Web server to one or more target computers which are connected through the Internet. Alternatively, an implementation of the present invention may be executing in other non-Web networking environments (using the Internet, a corporate intranet or extranet, or any other network) where software packages are distributed for installation using techniques such as Remote Method Invocation (RMI) or Common Object Request Broker Architecture (CORBA). Configurations for the environment include a client/server network, as well as a multi-tier environment. Or, as stated above, the present invention may be used in a stand-alone environment, such as by an installer who wishes to install a software package from a locally-available installation media rather than across a network connection. Furthermore, it may happen that the client and server of a particular installation both reside in the same physical device, in which case a network connection is not required. (Thus, a potential target system being interrogated may be the local device on which an implementation of the present invention is implemented.) A software developer or software installer who prepares a software package for installation using the present invention may use a network-connected workstation, a stand-alone workstation, or any other similar computing device. These environments and configurations are well known in the art.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

While there have been described above the principles of the present invention in conjunction with predictive billing collections, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A computer system for predictive billing collections, the computer system comprising:
a machine capable of executing instructions embodied as software; and
a plurality of software portions, wherein
one of said software portions is configured to record in a memory a plurality of received payments, wherein each payment is associated with a rendered service, a provider of the rendered service, and a payer of the rendered service;
one of said software portions forming a plurality of categories based on the rendered service, the provider of the rendered service, and the payer of the rendered service;
one of said software portions is configured to associate each of the plurality of received payments with one of the plurality of categories;
one of said software portions is configured to calculate an average payment for each of the plurality of categories; and
one of said software portions is configured to determine whether sufficient data is present for each of the plurality of categories of received payments to display said average payment.

2. The computer system of claim 1 wherein one of said software portions is configured to determine the number of received payments of non-zero value for each category.

3. The computer system of claim 2 wherein one of said software portions is configured to determine the number of received payments of zero value for each category.

4. The computer system of claim 3 wherein one of said software portions is configured to calculate a ratio of zero value received payments to non-zero value received payments.

5. The computer system of claim 4 wherein one of said software portions is configured to compare the ratio to a plurality of predefined values to determine whether said average payment is displayed.

6. The computer system of claim 4 wherein one of said software portions is configured to display said average payment when the ratio is less than 0.235.

7. The computer system of claim 1 wherein one of said software portions is configured to determine an average elapsed time from rendering of the rendered service to receiving payment for the rendered service.

8. The computer system of claim 1 wherein one of said software portions is configured to update said average payment responsive to associating an additional received payment to one of the plurality of categories.

9. A computer implemented method for predicting payment collections, the method comprising:
receiving a plurality of payments for services rendered;
recording in a first memory the plurality of payments, wherein each payment is associated with a rendered service, a provider of the rendered service, and a payer of the rendered service;
forming a plurality of categories based on the rendered service, the provider of the rendered service, and the payer of the rendered service;
associating each of the plurality of payments recorded in memory with one of the plurality of categories;
calculating an average payment for each of the plurality of categories;
storing the average payment for each of the plurality of categories in a second memory; and
determining whether sufficient data is present for each of the plurality of categories of received payments to display said average payment.

10. The computer implemented method of claim 9 wherein determining includes counting the number of received payments of non-zero value for each category.

11. The computer implemented method of claim 10 wherein determining includes counting the number of received payments of zero value for each category.

12. The computer implemented method of claim 11 wherein determining includes calculating a ratio of zero value received payments to non-zero value received payments.

13. The computer implemented method of claim 12 wherein determining includes comparing the ratio to a plurality of predefined values to ascertain whether the average payment is displayed.

14. The computer implemented method of claim 9 wherein calculating includes determining an average elapsed time from rendering of the rendered service to receiving payment for the rendered service.

15. A computer-readable storage medium tangibly embodying a program of instructions executable by a machine wherein said program of instruction comprises a plurality of program codes for predicting billing collections for services rendered said program of instruction comprising:
program code for receiving a plurality of payments for services rendered;
program code for recording in a first memory the plurality of payments, wherein each payment is associated with a rendered service, a provider of the rendered service, and a payer of the rendered service;
program code for forming a plurality of categories based on the rendered service, the provider of the rendered service, and the payer of the rendered service;
program code for associating each of the plurality of payments recorded in memory with one of the plurality of categories;
program code for calculating an average payment for each of the plurality of categories;
program code for storing the average payment for each of the plurality of categories in a second memory; and
program code for determining whether sufficient data is present for each of the plurality of categories of received payments to display said average payment.

16. The computer-readable storage medium of claim 15 wherein the plurality of program codes includes:
program code to count, for each of the plurality of categories, a number of non-zero payments and a number of payment denials,
program code to determine, from the number of non-zero payments and the number of payment denials, a ratio.

17. The computer-readable storage medium of claim 16 wherein the plurality of program codes includes program code to compare the ratio to a predetermined value to ascertain whether the average payment is displayed.

18. A computer system for predictive billing collections, the computer system comprising:
a machine capable of executing instructions embodied as software; and
a plurality of software portions, wherein
one of said software portions is configured to determine a projected payment for a particular type of rendered service associated with the particular type of service and associated with the particular type of service using historical payments; and
one of said software portions is configured to calculate when said projected payment is reliable.

19. The computer system of claim 18 wherein one of said software portions is configure to ascertain an average time period from issuance of an invoice for the particular type of rendered service to when the projected payment is received.
